(19) United States
(12) Patent Application Publication
(10) Pub. No.: US 2014/0081846 A1
(43) Pub. Date: Mar. 20, 2014

(54) Financial Advisor Platform

(71) Applicant: ADVISORADIT, Stoneham, MA (US)

(72) Inventors: Martha Gallagher, Wellesley, MA (US); Stephen Buscema, Haverhill, MA (US)

(73) Assignee: AdvisorAdit, Stoneham, MA (US)

(21) Appl. No.: 13/803,408

(22) Filed: Mar. 14, 2013

Related U.S. Application Data
(60) Provisional application No. 61/702,314, filed on Sep. 18, 2012.

(51) Int. Cl. G06Q 40/00

(52) U.S. Cl. CPC G06Q 40/00
USPC 705/39; 705/35

(57) ABSTRACT

Disclosed is a portal that receives provider content in various media from a plurality of provider sources to provide a private portal access to users and which allows users to select providers from the plurality of providers. The portal stores users own information as well as selected content from selected providers into a private firm archive where users can add comments and tags to the content and produces analytical data by comparing a provider's sales production data with a providers content consumption, to benchmark provider content consumption against other firms of similar nature. The portal reports user analytical data back to selected providers.

This application claims priority under 35 U.S.C. §119 to U.S. Provisional Patent Application Ser. No. 61/702,314, filed Sep. 18, 2012, and entitled “Financial Advisor Platform”, the entire contents of which are hereby incorporated by reference.

### INTRODUCTION

This disclosure relates to techniques for servicing financial advisors with information content.

The Internet is one mechanism that makes available content, most often presented as web pages, a page-sized formatted document with text, images, other media, and hyperlinks. Presently, there are around 12,000 advisory firms registered with the SEC and around 200,000 Financial Industry Regulatory Authority, Inc. (FINRA) registered representatives operating within the “independent advice” segment of the retail advisory market. A remainder of that market is large banks and “wirehouse” brokerage firms, i.e., firms that have branches offices linked together over a communications network for sharing of financial information and research. Much of the advisory market is fee based.

Providers such as mutual fund families, ETF providers, separate account managers, alternative investment managers, technology vendors, etc. seek to sell into the fee-based advisory market.

### SUMMARY

Challenges for providers exist to effectively sell into the advisory market. Barriers include independent advisors are markedly less impressed with wholesalers and “push” marketing strategies. Further, there are limited venues for providers to meet advisors to introduce advisors to provider offerings. Fee-based advisor are less visible to providers compared to commissionable business and thus challenging for providers to effectively profile them. While advisors are hungry for relevant market and product information and supporting research, they are being inundated by a barrage of calls, invitations, emails, and paper.

Disclosed is a system including server computer systems that provide a private portal to receive provider content in various media from a plurality of provider sources. These provider sources can be various sources. The portal allows users to actively select providers from the plurality of providers and it stores users' own information as well as selected content from selected providers into a private library where users can add comments and tags to the content. For the providers the portal captures user leads and content used by users and report user leads and content use back to selected providers.

According to an aspect, a system includes a server computer system including a processor and a memory executing a computer program for configuring the server system to provide a private portal to receive provider content in various media from a plurality of provider sources, allow users to actively select providers from the plurality of providers, store users own information as well as selected content from selected providers into a private library where users can add comments and tags to the content, capture user leads and content use by users, and report user leads and content use back to selected providers.

According to an additional aspect, a system includes a server computer system including a processor and a memory executing a computer program for configuring the server system to provide a private portal to receive provider content in various media from a plurality of provider sources, allow users to actively select providers from the plurality of providers, store users own information as well as selected content from selected providers into a private firm library where users can add comments and tags to the content, produce analytical data by comparing a provider's sales production data with a providers content consumption, to benchmark provider content consumption against other firms of similar nature, and report user analytical data back to selected providers.

According to an additional aspect, a method includes providing by one or more server computers a private portal to receive provider content in various media from a plurality of provider sources, allowing users to actively select providers from the plurality of providers, storing by the one or more computers users own information as well as selected content from selected providers into a private firm library where users can add comments and tags to the content, producing analytical data by comparing a provider's sales production data with a providers content consumption, to benchmark provider content consumption against other firms of similar nature, and reporting user analytical data back to selected providers.

According to an additional aspect, a computer program product tangible stored on a computer readable storage device includes instructions for causing a processor to receive provider content in various media from a plurality of provider sources to provide a private portal access to users, select providers from the plurality of providers, store users own information as well as selected content from selected providers into a private firm library where users can add comments and tags to the content, produce analytical data by comparing a provider's sales production data with a providers content consumption, to benchmark provider content consumption against other firms of similar nature, and report user analytical data back to selected providers.

The following are some of the features within the scope of the above aspects.

User actions on the content are shared with providers but a user's additions to the content are maintained private and are only shared with the express permission of the user. Detailed provider information is never shared with other providers. Users are authenticated as needed within recognized authorities. A fee is charged for access to the service. A plurality of servers can be used that are cloud based servers. Aspects produce analytical data to display provider content consumption trends and content usage and compare that to other firms of similar nature at an aggregate level. Detailed provider information is never shared with other providers. A registration process registers users to access the system by evaluating an entity against a database that stores user profiles to verify that the entity is a valid member of a regulatory organization such as FINRA/SEC or State Registered or affiliated with the entity being either the user or a firm that the user is associated with. Use of content is maintained private and is only shared with providers with the express permission of the user. Provider information is never shared with other providers. Aspects aggregate provider analytics across all providers and provide access to authorized third parties that serve an aggregate of provider information.

One or more aspects may provide one or more of the following advantages.

The portal will be especially useful to the registered as well as the independent advisor industry by offering advisors the ability to curate provider as well as their own information. The portal can drive client acquisition, retention and incremental provider revenues by levering proprietary technology and sophisticated analytics of member behaviors. This segment of retail-focused Advisors generates asset management revenues by collecting a certain percent of client assets, often 1% per year. This represents a substantial shift away from historical commission-based compensation models. Advisors select mutual funds, ETFs, separate accounts, alternative investments, annuities and insurance products as well as direct securities on behalf of their clients. Advisors typically share several key features such as taking an objective stance, “sitting on the same side of the table” as clients when evaluating products. As a result, Advisors seek low-cost and no-cost products, e.g., no-load funds and ETFs over higher expense or “loaded” products which contain embedded marketing and distribution fees.

Advisors cherish their independence and manage their operations as small businesses operating with limited budgets and staff and do not have internal access to deep research and extensive marketing, operations and compliance resources. Advisors have a fundamental need for provider content and quality interactions.

The platform is able to directly address all of these constraints and offer Providers expanded reach, quality and breadth of customer interactions. The platform provides an alternative to the limited communication channels available today email, snail mail, destination websites, phone calls and conferences. The platform will offer a highly professional platform that facilitates substantial relationship building between Advisors and Providers. The platform will offer Advisors a private portal to receive preferred Provider information in various media (e.g., PDF, podcasts, video, etc.). They can also store own information as well as Provider content into a private firm library where they can add comments and tags. The platform can be cloud-based.

Advisors actively select the providers they want to receive content from in contrast to indiscriminant email blast campaigns. Advisors are significantly more inclined to view and interact with provider delivered content that this self-selected or discovered by an advisor conducting a search. The platform offers providers the ability to capture leads and effectively focus on viable clients and prospects by understanding how content (PDF, podcasts or videos) they deliver to their clients through the platform is actually consumed. Unlike other campaign programs, where insight ends at the email interaction, the platform offers an ongoing view to the customer consumption patterns and usefulness rankings of a particular piece.

The details of one or more embodiments of the invention are set forth in the accompanying drawings and the description below. Other features, objects, and advantages of the invention will be apparent from the description and drawings, and from the claims.

### DESCRIPTION OF DRAWINGS

In some of the figures such as the wireframes, placeholder words in Latin are used and are not intended to be part of the description.

FIG. 1 is a block diagram view of a platform system.

FIG. 2 is a flow chart of login/registration process.

FIG. 3 is a flow chart of an overall process from an advisor perspective.

FIG. 4 is a diagram of an advisor (data consumer) user interface.

FIG. 4A is a diagram of an exemplary overlay on the advisor (data consumer) user interface.

FIG. 5 is a flow chart of an overall process from a provider perspective.

FIGS. 6-10 are diagrams of provider (data provider) user interfaces.

### DETAILED DESCRIPTION

Described is a web-based system including an application that provides a portal for consumers of information to access information on a selective basis furnished by providers of such information. This application would useful various types of business to business interactions that require an educated sales process where there are multiple vendors for the sales process to choose from. It is especially useful where the distributor is seeking to use intermediaries to distribute complex products. Examples of this include the pharmaceutical industry, the medical device industry, and the independent insurance agent industry.

One particular example is the system configured to handle information needs of registered investment professionals, otherwise known herein as “Investment Advisors” or more specifically “Advisors.” Investment Advisors typically advise their clients on retirement planning, estate planning, and managing assets. Advisors will sell a range of financial products to their clients. Advisors may be independent professionals or may belong to a firm containing a number of advisors. An advisor can be managing hundreds of millions of dollars in client assets upwards to multi-billions of dollars. An RIA (registered, independent advisor) is an investment professional that is independent, i.e., is licensed to sell investment products from any provider. Typically, RIAs have stricter licensing requirements and adhere to more stringent government oversight than a Registered Rep. RIAs are licensed with the SEC and are given a unique SEC identifier. Registered Reps are associated with a broker dealer and, similar to a franchise, are typically restricted to selling the investment products that the broker dealer offers.

Advisors provide a very personalized experience to their clients and are typically paid a fee that is based on a percentage of the assets that they have under management for their clients. Therefore, they have a vested interest in growing their client's portfolios.

The providers of financial products (financial services firms) spend an enormous amount of time and money producing marketing materials and trying to influence advisors to sell their products. They will typically cold call advisors and mail (snail mail) very high-end printed brochures. Advisors by contrast, do not want to be cold called and have little bandwidth to consume unsolicited product materials. Advisors do have a need for these materials and information, but want to be able to consume it on their time, on their terms, in an environment where they can consume it and manage it intelligently.

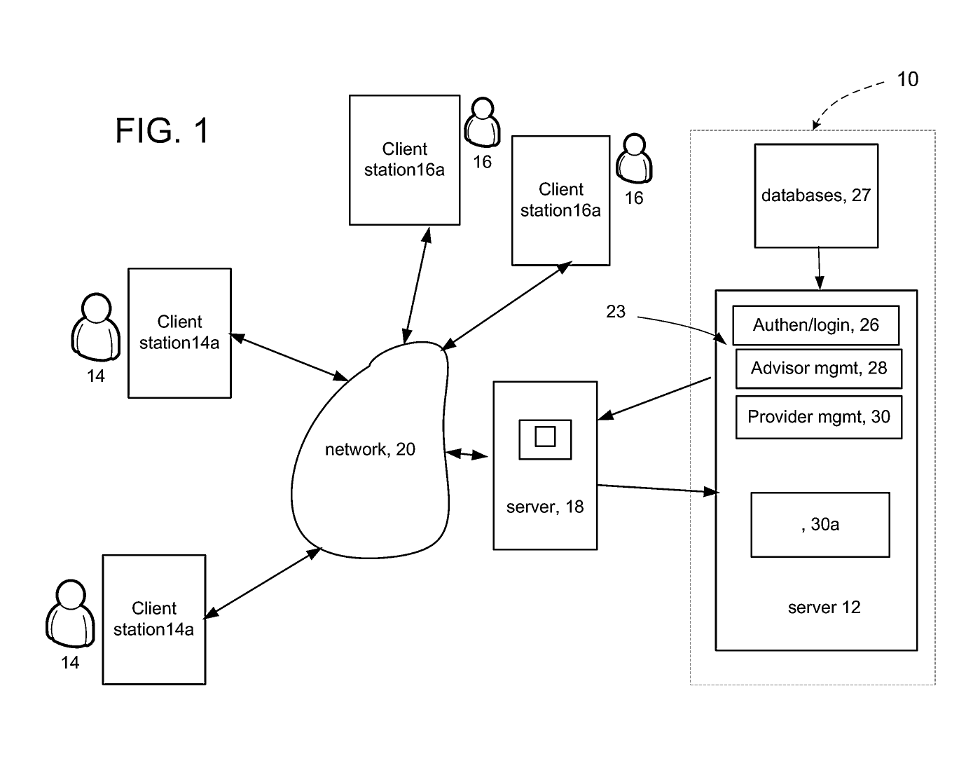

Referring now to FIG. 1, an exemplary networked computer system (platform) 10 for an advisory platform includes a computerized system or server 12 for processing requests from advisors 14 at client stations 14a to obtain information with providers of financial products 16 at provider systems 16a. The server can be one of a plurality of servers and the plurality of servers can be cloud-based servers. The networked computer system 10 implements a financial advisory platform as a web-based application 23. The networked computer system 10 includes a web server 18 to receive on-line web-based requests and web-based communication channels from provider systems 16a using a web browser or the like. Web server 18 can be part of or separate from server 12 and indeed these servers can be distributed and cloud-based.

The platform 10 changes the way that advisors consume and interact with provider information. Advisors see and accordingly work with only content that they desire to work with supplied from providers that they have established relationships with. Advisors manage their own and their firms' content in electronic libraries maintained in the database 27 by the platform 10. Providers offer their materials for storage on the platform in a manner that the materials are easily searched and retrieved by advisors and ultimately accessed and consumed. Providers gain insights into usage patterns (both by clients individually and in the aggregate) that in turn allows the providers to produce materials and offerings that are more effective. The platform 10 will enable advisors and their firms to view and manage provider content as well as view their own internal content (white papers, research, etc.) by uploading it to the platform 10 for storage in databases 27.

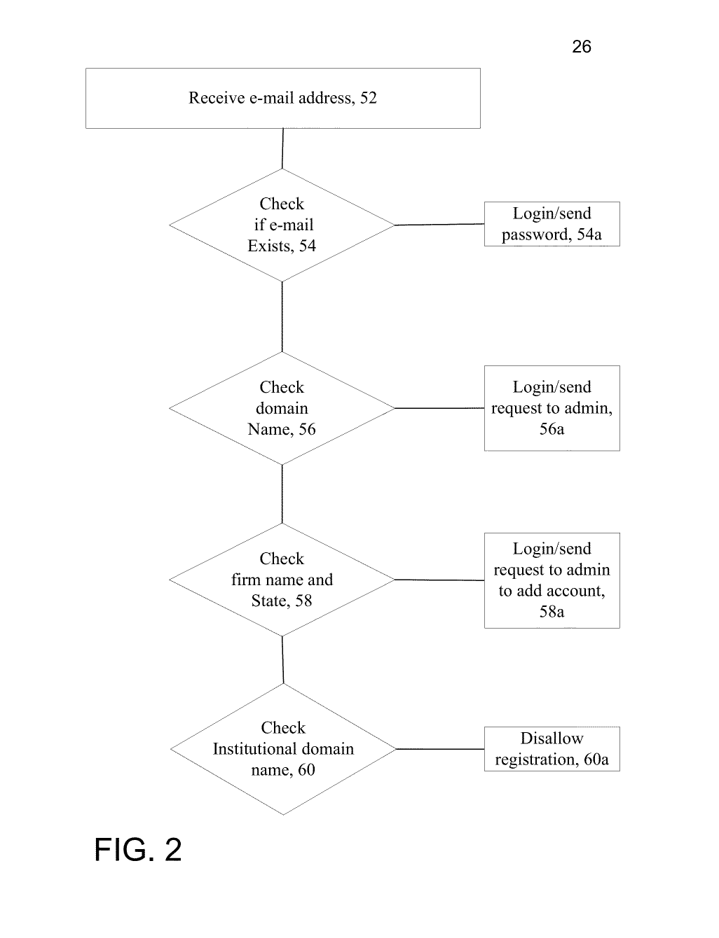

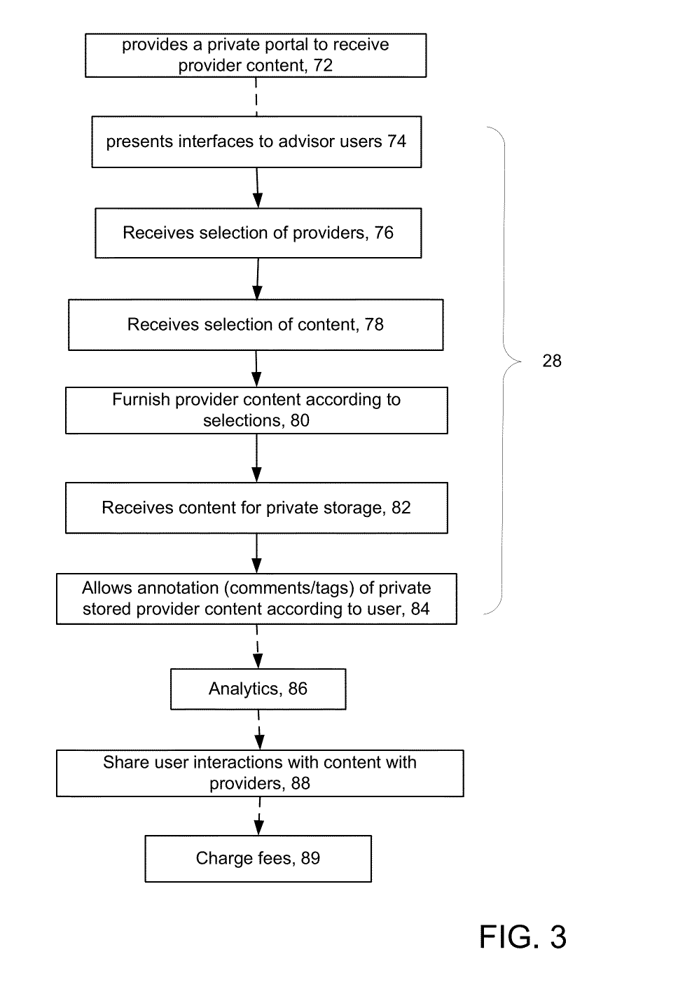

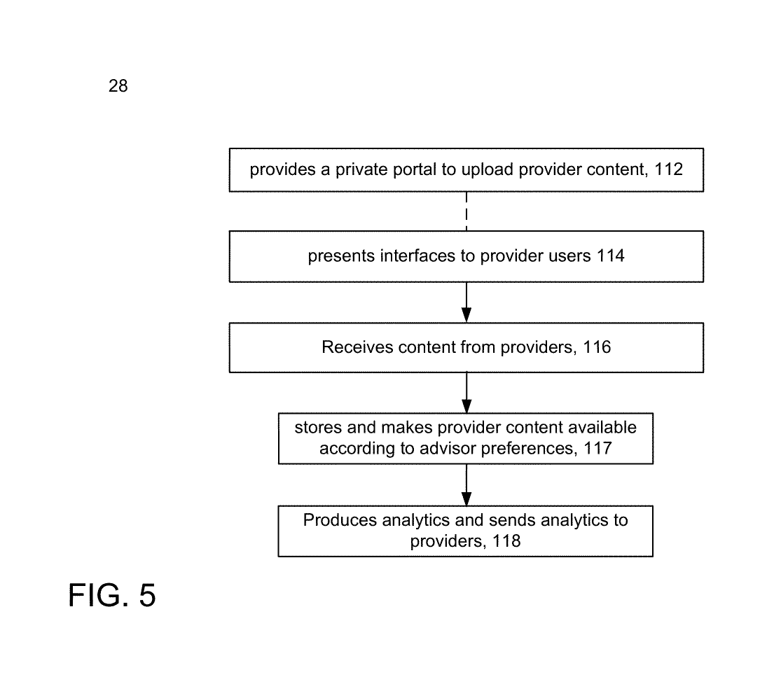

The server 12 executes various processes that are part of the application 23. Included are an authentication and registration process 26 (FIG. 2), advisory management processing 28 (FIG. 3) and provider document management processes 30 (FIG. 5).

An Advisor Firm entity is represented in the platform as a table in the database 27 that contains information about Firms. Each firm can have one or more advisor users associated with it. Each investment advisor has his or her own account within the platform. An Advisor Firm can also have one or many users with the permission (Advisor Administrator permission) to be able to edit information about the firm itself, as well as to manage user accounts that are associated with the Advisor Firm. All Advisor Firm Entities are validated against a third party database as part of the registration process to insure there are meet specified regulatory or legal requirements according to jurisdiction, e.g., in the US, Financial Industry Regulatory Authority (FINRA)/Securities and Exchange Commission (SEC) or State registered authorities, or that they are affiliated with an entity that meets such requirements, as applicable. Users who are registering for the platform as Advisors will first be prompted whether they are an RIA or not.

Referring now to FIG. 2, authentication 26 uses a user's email address to serve as their username/user ID. Alternatively, the system can provide a user ID. The platform receives the e-mail address 52. If the email already exists 54 the platform notifies user and prompts for login and/or password recovery 54a. Otherwise, if the firm does not already exist in the system, then the platform will use the third party database to verify the validity of the user's firm. This database maintains data on Registered Investment Advisors (RIAs) as well as Registered Reps.

Both RIAs and Registered Reps are considered advisors with respect to the platform 10. However, RIAs are verified during authentication in a different manner than Registered Reps. The authentication process is modified for a registered representative in that authentication does not check e-mail domain because the register representative is part of a larger firm. The unique name of the firm is used for registered representatives, but not e-mail domain. The principal of authentication is the same where the platform 10 checks certain data fields against FINRA, state and SEC databases to validate that the individual is a financial professional in good standing.

User will be prompted 58 to provide their firm name and the city and state in which the firm is located. If they are an RIA then the firm name will be matched against the database for which there should be a match and a unique identifier (the SEC identifier for RIAs which is included in the database). If more than one firm with the same name exists, then prompt the user to enter their street address (e.g. 123 North Street) to narrow the match. During this process the platform should not be displaying the actual partial matches to the user. The platform provides a message to the user indicating that their firm could not be verified and that they should contact the platform to provide more information. Once they make contact, then the platform representative would manually verify the firm.

If an exact match can be made against the database, then there will be a second verification 56 where the domain name of the user's email address will be checked to see if there is a website active with the domain name. For example, if the user enters domain name as part of an email address then the platform will check to see if that is a valid website domain name. If yes, then user can proceed with other registration process. If no, then user will see a message indicating that they contact the platform to provide further information.

Further, when users are registering, if there is already a match on the user's email address to a valid account in the system, then the user should be prompted to log in. For example, if user's email address is chad@xyzcapital.com and there is already a firm entity “Xyz capital” in the system with users that have email addresses with the domain of @xyzcapital.com” then users should be notified and have the ability to login or send request to admin of Xyz capital to be added to account. Also, if user attempts to register with email with a different domain, but enters “XYZ Capital” as the firm name and there is already a match for firm name, then user will have the option to login or ask the firm admin to be added to the account.

If the user's email domain does not match an existing firm, and the firm name that the user entered does not match an existing account, then the user may proceed with registration and payment. By default, the user who sets up a new account with a new firm associated and pays, will become the firm administrator role for that firm. The payment information and subscription information will be associated with his/her user ID. Even though other users in the firm may be assigned a user role of Firm Administrator, the initial account producer will always be the account admin by default. Once the basic account information is entered, the user will be prompted to enter some information about their firm (some number of fields). If possible, the platform would pre-fill this information using the database. Finally, the user will be prompted to enter payment information. Payment will be via credit card.

Referring now to FIG. 3 an overview of the platform 10 operation especially with respect to advisor management 28 (provider functionality is shown by phantom connecting lines) is shown. The platform 10 provides 72 a private portal to receive provider content in various media from a plurality of provider sources. The platform 10 presents 74 interfaces to advisor users as discussed above that allow the advisor users to actively select providers from the plurality of providers of content that the advisors elect to deal with. The platform 10 in response to receiving 76 these selections and content selections 78 made by the users using interfaces for example as discussed below, furnishes 80 provider content to the advisor. according to the selections made by the advisor.

The provider information can be stored into various libraries in database 27. In addition, the platform 10 is configured to store 82 advisor users own information as well as the selected content from selected providers into a private library where users can add 84 comments and tags to the content. The platform applies 86 analytics to capture user leads and content use by users such as applying analytics to capture usage patterns of content and reports such user leads and content use back to the corresponding providers. For example, the platform 10 produces analytical data by comparing a provider's sales production data with a provider's content consumption to benchmark provider content consumption against other firms of similar nature and report the analytical data back to the providers. The platform 10 is configured to produce analytical data that is displayed to providers and involves content consumption trends and content usage. The analytics produced for a provider can be compared that to other firms of similar nature at an aggregate level. Detailed provider information is not shared with other providers or advisors. The received provider content can be in various media forms, such as text documents, video, webpages, links etc. However, the platform 10 can be configured to aggregate provider analytics across all providers and make that analytic information available to authorized third parties such as custodians and broker/dealers, etc. or other entities that serve as an aggregator of provider information.

The platform is further configured to share 88 user actions on the content with providers. However, a user's annotations to the content are maintained private and are shared only when the platform receives an express permission of the user. The platform 10 is further configured to charge 89 user advisors a fee for access to the service.

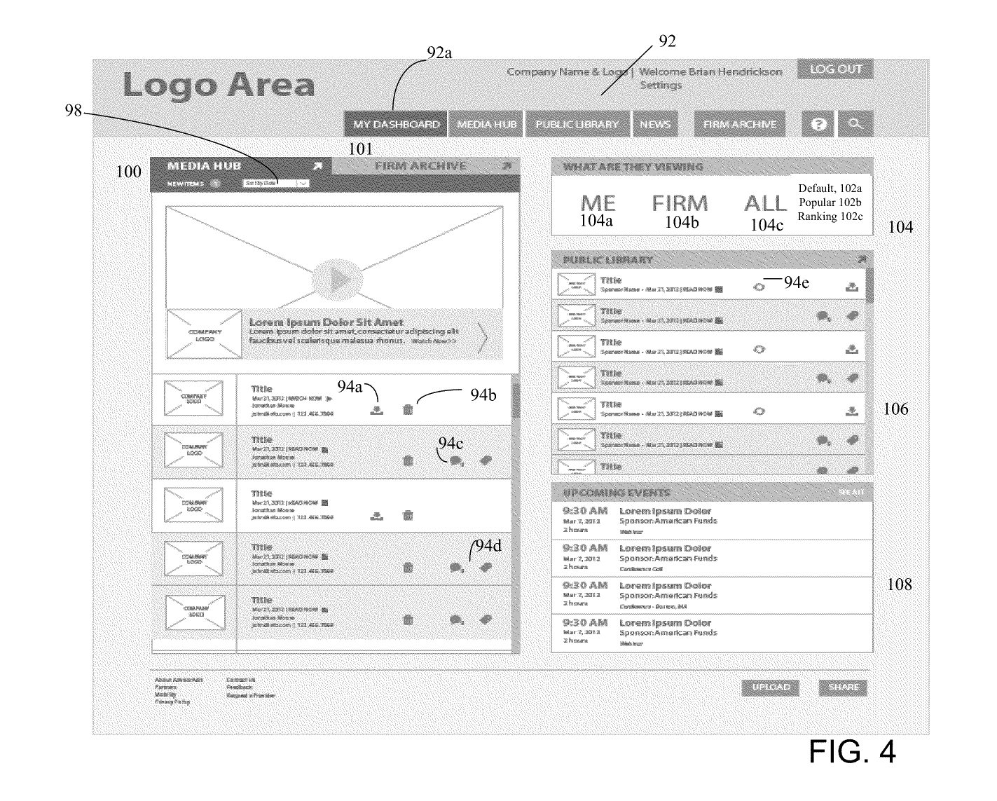

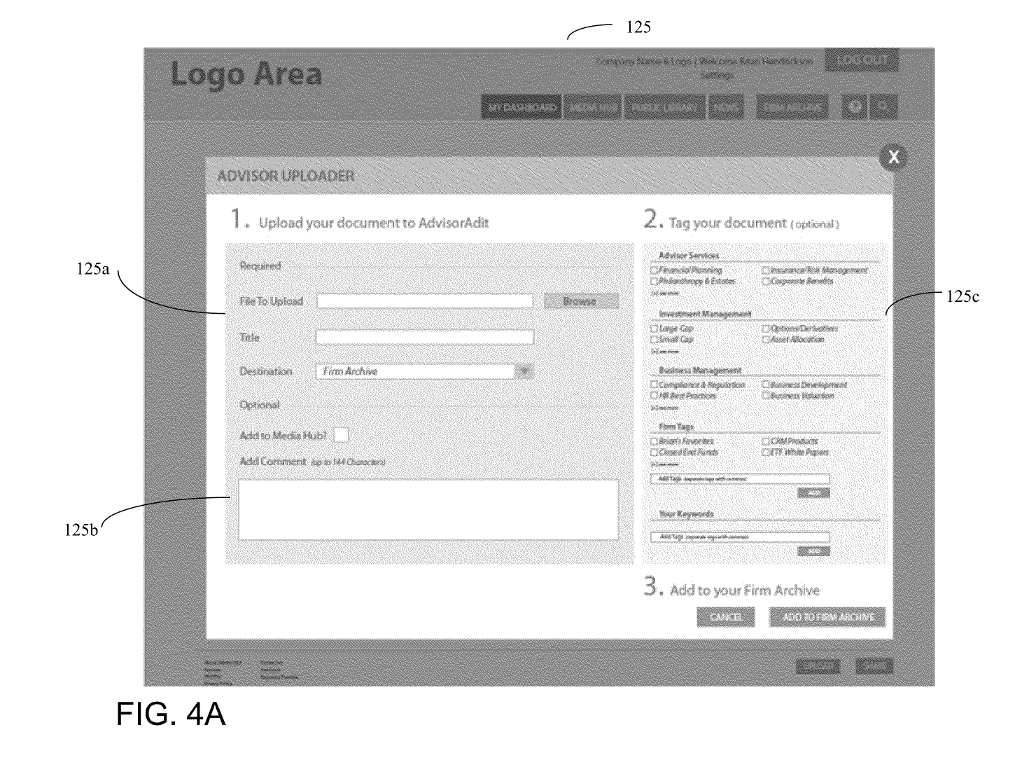

Referring now to FIG. 4 an advisor console 90 includes a series of tabs 92. A “My Dashboard” tab 92a enables advisors to view only desired content. The “My Dashboard” tab 92a can be an initial view or when activated provides a quick view of the various functionality that the platform offers to advisors. The full views are accessed through remaining tabs 92 across the top or through a ‘see More” within a quick view. The advisor console 90 includes some common icons and controls that are present on the Dashboard tab 92 and throughout applications executed on the platform 10. The actual icons used can be depicted differently but will have the general functionality.

One icon is a “Store” icon 94a that sends content into the user's Firm private archive. Only users authorized by the client will have access to an archive (based on permissions) and therefore only certain users within the advisor firm can add documents to the private archive. If an item has already been added to the firm's archive, then the “store” icon would no longer appear. Users can add comments to an item, however users can only comment when the item been added to the user's archive. Once a content item has been stored, the background color of the row associated with the item will be shaded to indicate that is has been stored.

A “Trashcan” icon 94b enables the advisor to remove items from view on a personal level, e.g. where the user has already read the content and would like to hide it so that it does not appear again for that individual user although the content is still searchable by that user. An item that is hidden in the Dashboard view will also be removed in expanded views of the corresponding area.

A “comments” icon 94c will display the comments overlay and allow the user to view the comments associated with the article and also to comment on a content article if the user is permissioned to do so. The article is first stored within the firm's archive in order for it to be commented on. A tag icon 94d will display the tagging overlay and will enable the user to tag the content item. An engage icon 94e enables a user who is permissioned to engage with the provider of the content item.

If an advisor firm is already engaged with the provider, then the content item will appear in both the Public Library (e.g., a leading insights library) and also the Media Hub (e.g., a research hub). If the user is not engaged with a provider, the advisor can still store it in Firm Archive without being engaged with the provider and will be able to view it from the firm archive.

The platform generates confirmation message overlays in certain conditions when a user makes a change to an account or when exiting a view/screen where they have initiated but not completed an action. The overlay is contextual and will typically present the user with options such as continue, cancel, etc.

The My Dashboard tab 92 include a simple “search bar” 98 for users to search as well as a way to access advanced search capabilities. Selecting the search tab icon will pop-up a search box as an overlay in the form of a small search field drop-down menu (not shown). Executing a search will search all content repositories (Media Hub, all content from engaged firms, the Public Library, the Private Archive, and the Calendar content). Users will view the search results from within the “Search” tab. By default search results are shown according to relevance. The platform 10 can use services to define relevance.

Highlighted Content is a single item of content that is drawn from the “Media Hub” stream of content and displayed prominently in area 100. An algorithm/method for determining which content gets shown as the Highlighted Content can include various factors including the content title, media type, and provider logo (or other image) displayed in a carousel style where the content shifts every few seconds. Highlighted Content can include papers, video, etc. For example, a white paper may show a thumbnail image that was uploaded along with the content. If no thumbnail available, a standard icon/thumbnail that represents a whitepaper can be displayed. Other functional items include a New Items Indictor that displays the number of new items added to the Media Hub since the user's last session, a sort filter allows the user to change the order of the media hub items to re-order by different criteria, and a section that display what other people are viewing and what they are saying about the content.

Filter options include default 102a, “Popular” 102b and “Ranking” 102c options. There are three buttons 104a-104c for “ME”, “FIRM”, and “ALL” in area 104 that changes the view of content according to the selected option, e.g., ME will show content of user, Firm content of others in the firm and All will show all users over a period of time or number of documents. A “Ranking” filter sort items based on the average rating of all users within the platform community that have rated the content. A “Popular” filter will sort items based on the number of views of the article (how many users in the platform community—all users—viewed the article)—essentially the popularity of the content amongst all users. Other controls could be included.

A Media Hub dashboard widget provides a “stream” of content displayed to the Advisor on the Dashboard 90 as it becomes available to the platform 10. All items in the Media Hub are either content that was added from a Provider that the Advisor's Firm has a relationship with or content that was saved to a Firm Archive sub tab 101 by an advisor user (content saved to the Firm Archive will automatically get displayed/streamed into the Media Hub. The items displayed with the Media Hub 100 will be co-mingled by provider and by the firm's own content. ‘Firm Archive’ sub tab 101 functions like the ‘Media Hub’ sub tab but will contain items that have been added to the firm's archive.

The Public Library 106 is a collection of content that has been added to the system by all Providers and displayed on the user's Dashboard whether or not the Advisor has a relationship with the Provider that posted it. A Public Library widget will contain a set number of items in within the viewing area on the Dashboard.

An Upcoming Events area 108 enables Advisors to be aware of events and activities (conferences, webinars that are hosted/sponsored by Providers. An Upcoming Events widget will display events by Providers that the Advisor Firm is engaged with. Users can click an Upcoming Events item from the Dashboard and see a view which provides the details of the particular event that was selected (not shown).

Although not shown, the Upcoming Events area 108 displays a ‘calendar’ view area that displays the details of the event. The platform also indicates an “Attendance event” indicating that an event is a physical event where attendees appear in person. A ‘Register for Event’ button will be displayed if registration is required. If registration is not required, then a ‘Send Calendar Invite’ button will be displayed. A “Share” button allows a user to invite a friend and bring invitee to home page. The recipient would receive an email with a link which would bring the user to a “splash page” where the recipient can see some basic information about the platform and call/email/contact form for more information.

Public Library Tab 106 contains content from Providers that the Advisor's firm does not have a relationship with. The tab is an expanded view of the Public Library widget on the Dashboard.

Permissioned Advisors can add any content type to the firm's archive (Firm Archive) section and it will be accessible by any user within the firm. When the content is added, the content will stream through the Media Hub section is chosen by provider, which will provide added exposure to the content piece. For example, the content may be found in a search, but the content could be surfaced from the “Public Library” by a Provider that the firm does not yet have a relationship with. A user from within the firm can then add the piece of content to the Firm's Archive. It will then be accessible later to any user within the firm. The content would also stream through the Media Hub for users within the same firm. When content is moved to the Firm Archive from the Public Library, this activity will be tracked so that reporting can be generated (which firms found which content interesting, which ones by Providers they did not have a relationship with, etc.).

Referring now to FIG. 4A, an advisory upload overlay 125 is shown. This overlay 125 includes an area 125a that identifies a document or other content, a comments area 125b and an area 125c for tagging the content.

Referring now to FIG. 5, the platform 10 process 30 (FIG. 1) enables providers and their authorized employees to upload content into content libraries stored in storage 27 (FIG. 1). The platform provides 112 a private portal to providers. The platform presents interfaces to provider users, 114 and receives 116 provider uploaded content, stores and makes available the provider content 117, and produces and sends 118 to providers reporting and analytics to assist providers in better understanding advisor usage patterns and effectiveness of the materials being consumed by advisors over the platform 10. The platform 10 can charge 120 providers for access to the platform 10.

The platform 10 allows advisors to access to content anywhere/anytime, controls which providers have access to that advisor's information portal (“media hub”) based on advisor-established relationships, and controls access to and use of a “private library” for allowing advisors to save provider content as well as their own content. The platform provides tagging and key word searching capabilities that let advisors easily access important information. In some embodiments, advisors have multiple seats without additional charges, whereas in other embodiments advisors are charged on a per seat basis.

The platform 10 enables providers to post up to a specific number of items per month and a certain number of items per year for posting to the Public library. The number is determined based on various considerations and can be several, e.g., 2-7 to many 10's or 100's or can be an unlimited number.

Providers are users who are employees of companies that provide financial service information to advisors. Within these companies, there are employees with various responsibilities for sales, marketing, and business development (see User/Buyer Personas). Uses of the Provider role will typically be interested in using the platform 10 to upload their company's marketing materials, viewing usage statistics of their content, and interacting with Advisor users who chose to engage with them. Each Provider user will be tied to a Provider Company record in the database so that each Provider Company could have multiple users with the role of Provider associated with it.

Various overlays are generated over the interface 90 including an upcoming events overlay that provides the advisor with details on a particular event. A comment viewer can be provided as an overlay to view comments made by an advisor on private stored materials. Another overlay is a share overlay that contains contact information on persons' names that shares comments and who the comments are shared with.

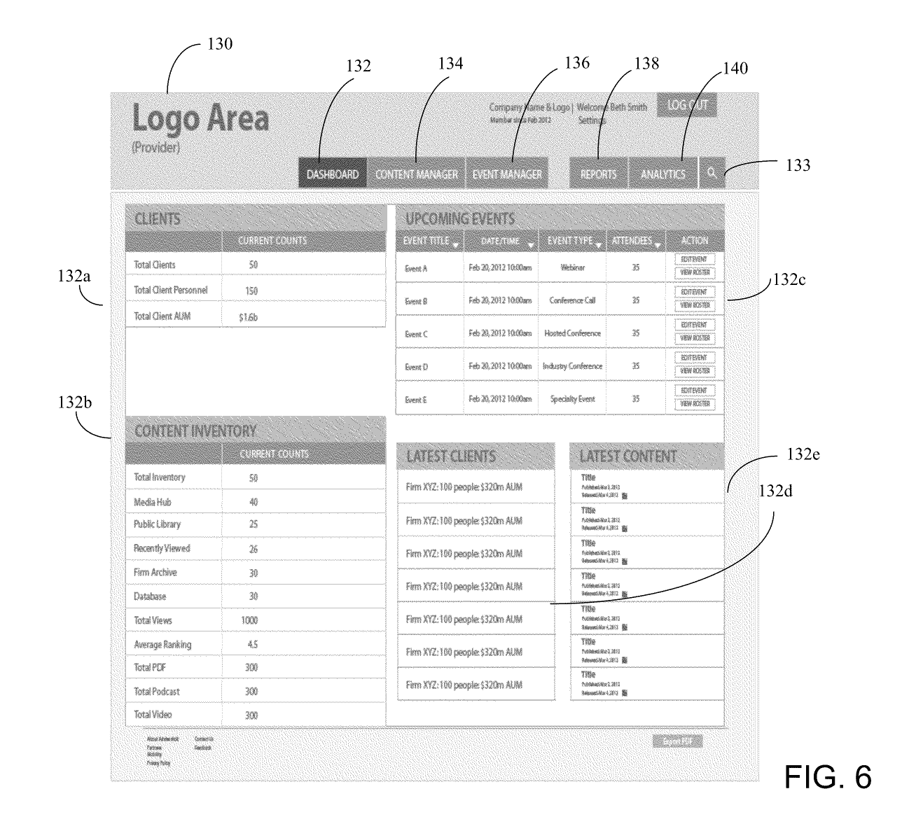

Referring now to FIG. 6, upon logging-in, Provider users will see an interface 130 that is specific to Provider task functionality. Provider tasks will be centered upon uploading and managing their content, engaging with advisors, as well as reporting and analytics. The main tabs of the provider interface include a dashboard tab 132 (shown by default) that provides an overview of information that is useful for providers. Also included is a content manager tab 134, an area where providers manage all aspects of content including uploading pieces, adding tags and key words, and setting release and expiration dates. A reporting module tab 136 is also provided to monitor piece inventory and status. Also included is an Event Manager tab 136 for Providers to publish upcoming events, webinars and conferences for Advisor attendance to all or targeted engaged clients and a reports area where providers can obtain detailed reporting according to item and client. Analytics tab 140 can be add-pay services that are outside the platform product. For example—comparing a provider's sales production data with their content consumption or benchmarking their content consumption against other firms of similar nature.

The Dashboard tab 132 has of five panels/modules, two of which are interactive including the client Stats area 132a that provides information on the “clients” (Advisor Firms) that a provider is engaged with, a Content Inventory area 132b will provide the Provider with insight about current counts related to provided content inventory, as well as “Database” that refers to content that has been loaded into the database but is not yet visible to users in the Media Hub or Public library and “Recently Viewed” a metric by which users can see how many pieces of content were viewed over a certain time frame. An Upcoming events area 132c will give Providers a sense of who has been signing up for their events and a Latest Clients area 132d will provide the user with insight into some of the latest clients (Advisor Firms) that the Provider has engaged with and Latest Content 132e shows the most recent content items that the provider added to the system. A Reports area 132f enables the provider user to access all available reports via a drop-down selector. Selecting a report will load the report into the main viewing area. A search 133 for firm allows the user to find a specific Advisor firm in the report.

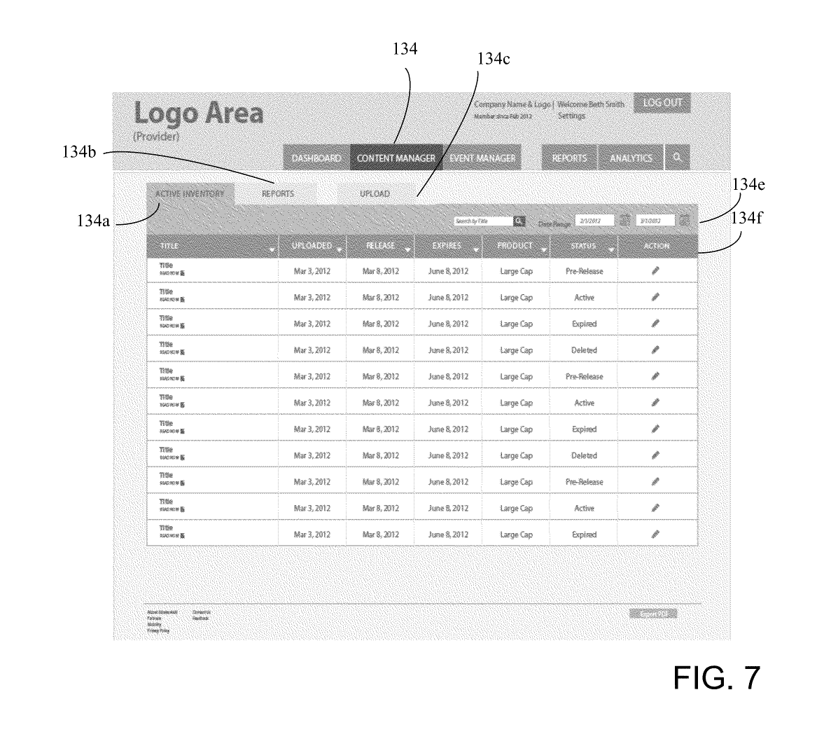

Referring now to FIG. 7, the Content Manager tab 134 when selected provides to Providers a mechanism to upload and manage content on the platform 10. The Content Manager tab 134 can include plural sub-tabs 134a-134c, here three sub tabs are shown and organized as ‘Active Inventory’, ‘Reports’, and ‘Upload.’ The Active Inventory Sub Tab 134a (shown) displays all active content that the Provider has within the platform application. A search function 132e allows users to search by title name or date range, etc. and the results will be retrieved according to the search.

An action column 134f allow user to edit a document's details by opening an “Edit Document” view in an overlay (not shown). Reports sub tab 134b in Content Manager 134 is used to display all of the active content that has been uploaded by the provider. Reports sub tab 134b has similar functionality at those discussed above. An Upload sub tab 134c within Content Manager enables users to upload and tag content.

The edit document overlay (not shown) within the Content Manager enables providers to edit the details of documents that have already been uploaded into the system and will also enable them to delete documents.

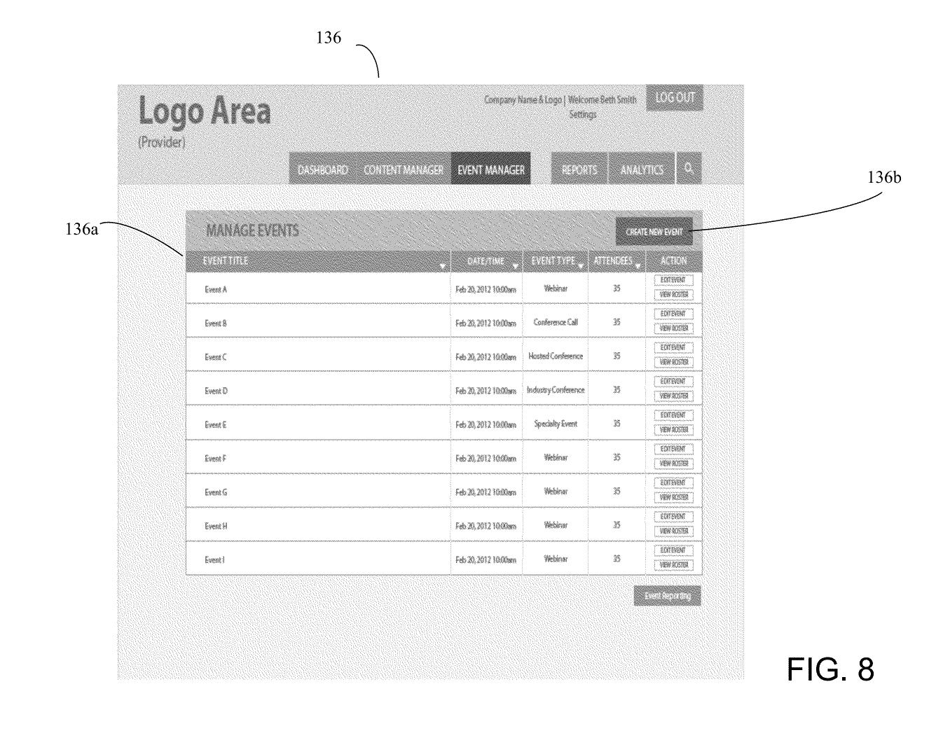

Referring now to FIG. 8, the Event Manager tab 136 enables providers to manage events accessible via the platform 10. The event manager tab 136 renders a list 136a of current events that are in the platform 10 and details including Event title (sortable), Date/time (sortable), Event type (sortable), e.g., the type of event (e.g., webinar, conference call, etc.), number of Attendees (sortable), and an Action (sortable) field that allows user to edit details of the event and to view a roster of attendees. Produce new event 136b allows a user to produce a new event, and Event Reporting brings user to an Reports/Events view. The edit event view (not shown) is an overlay that appears when the user clicks the edit event button within the action column. Allowing all details of the event to be edited, e.g., event title, description, time/date, duration, event link (URL to the event webpage), event type, whether registration is required, whether event repeats, upload of documents, allows a user to duplicate the event and to delete the event and notify registrants via an email to registrants with the event information and saves the event and makes available immediately to all users in the system.

A Create Event view (not shown) will be displayed in an overview and will enable providers to enter a new event into the system. The fields here will be the same as the Edit Event view except that there is a file upload capability for uploading PDF documents.

The analytics tab 140 when selected presents a view (not shown) that displays charts and other graphical representations of data to help providers better understand the effectiveness of content consumption within the platform 10. The interface allows a user to select comparative charts that allows the user to select several charts at a time and compare the data between them.

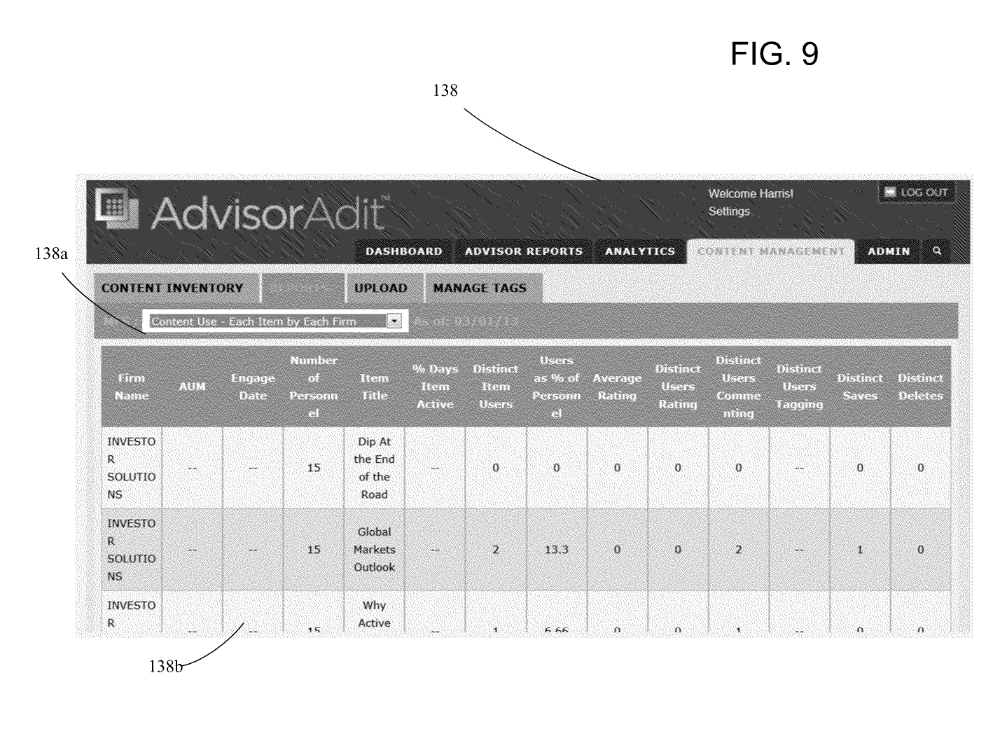

Referring now to FIG. 9, a reporting section 138 provides reports that are specific to the content that the Provider has available within the platform 10. The reports are selected from a pull down control 138a by type and include various types of reports. One type of report (Content use each item by each firm) has statistics such as how many users viewed a particular content item, which firms, average time spent, average rating, etc., saves, etc. as illustrated. The report drop down 138a allows users to select other types such as content inventory, item status, content inventory, all member personnel to run a report on. Selecting a new content item will load a report into main viewing area 138b that is specific to the type chosen. Searching can be by title of content or date range. The report area 138b displays results in tabular format.

Providers can review reports about the content consumed by the clients (Advisors) that they are engaged with. The Client reports provide information about clients including firm changes, personnel changes, firm information, assets under management (AUM) stats, etc.

Various overlays are generated over the dashboard including a Firm Profile Overlay when a user drills into a firm link from within one of the reports. This overlay provides the provider with details on the particular firm that was clicked on within the reports. The information in this overlay is provided from the Advisor profile. Another overlay is a Personnel Profile that contains available information on a person's name clicked within a report—i.e. the individual user of the system. The information in this view would have been captured when each individual user account was produced by an administrator at the advisor firm, or would be the information related to the first user from the firm who produced the platform account from within the registration process.

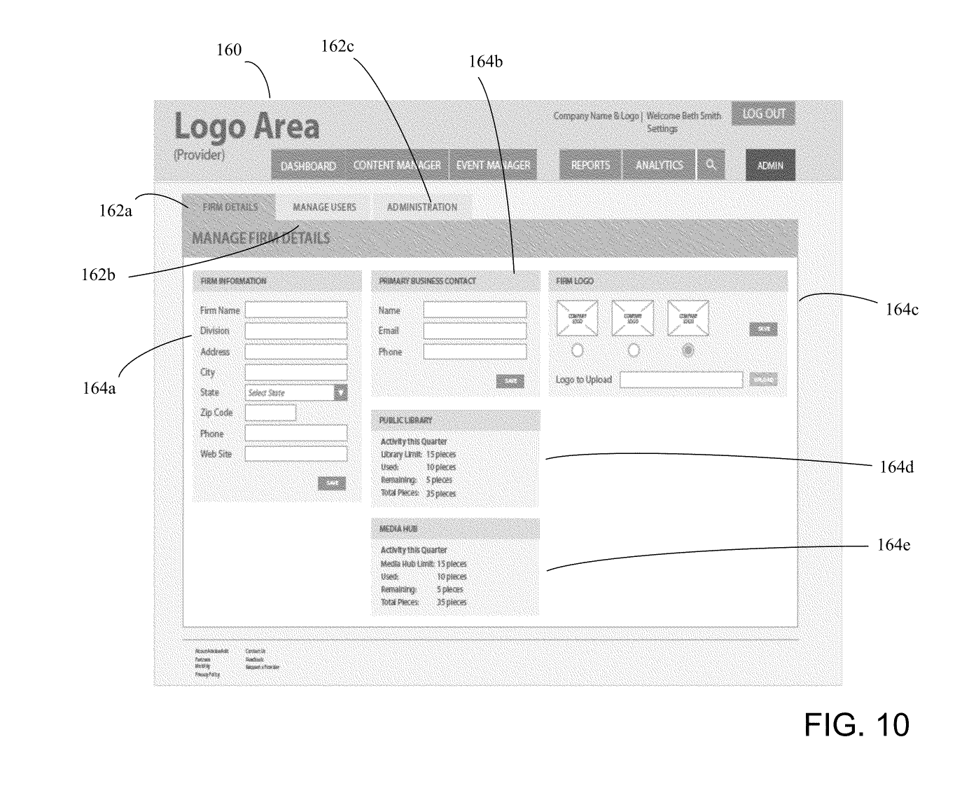

Referring now to FIG. 10, a Provider Admin interface 160 enables Provider Administrators to manage details of how their company information is displayed within the platform 10. The Provider Admin interface 160 includes three sub tabs “Firm Details” 162a, “Manage Users” 162b, and “Administration” 162c. The “Firm Details” tab 162a is active by default. Firm Details tab 162a enables provider administrator to manage information about their company. Here there are five panels, Firm Information 164a, Primary Business Contact 164b, Firm Logo 164c, Public Library 164d, and Media Hub 164e.

Firm Information area 164a includes name, address, city, zip, etc. of the firm. The Primary Business Contact information area 164b includes information of the company's primary business contact. The Firm Logo area 164c enables a provider to upload one or more logos into the platform for use in various interfaces, etc. Public Library area 164d lists activity statistics for the present quarter regarding the firm's documents in the public library including the provider's limit that it is allowed to upload into the library, the total number of pieces that it has uploaded in the current quarter, and the total number of pieces that the provider has in the public library. The Media Hub area 164e provides media hub-related statistics for the current quarter including the provider's quarterly limit, number of pieces it has uploaded, pieces remaining, and total number of pieces available in Media Hub.

Provider Engagement Information (not shown) has input for where providers can enter a text message or jpeg that is displayed in the box within the PDF viewer.

The Manage Users sub tab 162b will enable provider administrators to manage the users that have access to their account, along with their privileges. The Manage Users view (not shown) will contain panels including user information, professional role, and privileges. User Information includes fields necessary for producing a provider user account including name, title, email, etc. Professional role user is assigned one professional role from checkboxes. Privileges user assigned one or more roles.

The Administration sub tab 162c provides a list view of existing users and lets the admin user edit the users and edit the user's privileges. This view includes three panels (user status & privileges, Tags, and Tickers). All fields will be pre-populated with data where available.

The platform Administration Console 160 enables platform employees to administer general system settings and capabilities as well as to administer accounts on behalf of both Providers and Advisors. One of the features of the platform 10 Administration interface is for a platform employee to see application in the same views as the provider administrator or the Advisor Administrator role would see such views. This is accomplished by a selector control that will enable the user to select which view they would like to see (Admin, Provider Admin, or Advisor Admin). A “Search Firms” search bar allows the platform Admin to be able to look-up an account for either an Advisor or a Provider by entering the account name into the search bar. The platform Admin can edit any aspect of the chosen account. The functionality similar to the Advisor Admin console discussed above. For example, for a Provider View Firm Details the admin area will mirror the functionality of the Provider Admin section exactly (same actions, same field editing, uploads of content, etc.).

The invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

One such type of computer includes a programmable processing system suitable for implementing or performing the apparatus or methods of the invention. The system includes a processor, a random access memory (RAM), a program memory (for example, a writable read-only memory such as a flash ROM), a hard drive controller and an input/output (I/O) controller coupled by a processor bus. The system can be preprogrammed, in ROM, for example, or it can be programmed (and reprogrammed) by loading a program from another source (for example, from a floppy disk, a CD-ROM, or another computer).

An execution environment includes computers running an operating system and browsers. Other environments could of course be used.

A number of embodiments of the invention have been described. Nevertheless, it will be understood that various modifications may be made without departing from the spirit and scope of the invention. Accordingly, other embodiments are within the scope of the following claims.

What is claimed is:

1. A system comprising
a server computer system comprising
a processor; and
a memory executing a computer program for configuring the server system to provide a private portal to receive provider content in various media from a plurality of provider sources;
allow users to actively select providers from the plurality of providers;
store users own information as well as selected content from selected providers into a private library where users can add comments and tags to the content;
capture user leads and content use by users; and
report user leads and content use back to selected providers.

2. The system of claim 1 wherein user actions on the content is shared with providers but a user's additions to the content is maintained private and is only shared with the express permission of the user.

3. The system of claim 1 wherein detailed provider information is never shared with other providers.

4. The system of claim 1 further configuring the server to
authenticate users and firms as needed within recognized authorities.

5. The system of claim 1 further configuring the server to
charge users a fee for access to the service.

6. The system of claim 1 further configuring the server to
charge providers a fee for access to the service.

7. The system of claim 1 wherein the server is one of a plurality of servers and the plurality of servers are cloud based servers.

8. The system of claim 1 further configuring the server to
produce analytical data to display provider content consumption trends and content usage and compare that to other firms of similar nature at an aggregate level.

9. The system of claim 1 wherein detailed provider information is never shared with other providers.

10. The system of claim 1 further configuring the server to
perform a registration process to register users to access the system, with the server further configured to:
evaluate an entity against a database that stores user profiles to verify that the entity is a valid member of a regulatory organization such as FINRA/SEC or State Registered or affiliated with the entity being either the user or a firm that the user is associated with.

11. A system comprising
a server computer system comprising
a processor; and
a memory executing a computer program for configuring the server system to provide a private portal to receive provider content in various media from a plurality of provider sources;
allow users to actively select providers from the plurality of providers;
store users own information as well as selected content from selected providers into a private firm library where users can add comments and tags to the content;
produce analytical data by comparing a provider's sales production data with a providers content consumption, to benchmark provider content consumption against other firms of similar nature; and
report user analytical data back to selected providers.

12. The system of claim 11 wherein user use of content is maintained private and is only shared with providers with the express permission of the user.

13. The system of claim 11 wherein detailed provider information is never shared with other providers.

14. The system of claim 11 further configured to:
aggregate provider analytics across all providers; and
provide access to authorized third parties that serve an aggregate of provider information.

15. A method comprising
providing by one or more server computers a private portal to receive provider content in various media from a plurality of provider sources;
allowing users to actively select providers from the plurality of providers;
storing by the one or more computers users own information as well as selected content from selected providers into a private firm library where users can add comments and tags to the content;
producing analytical data by comparing a provider's sales production data with a providers content consumption, to benchmark provider content consumption against other firms of similar nature; and
reporting user analytical data back to selected providers.

16. The method of claim 15 wherein user use of content is maintained private and is only shared with providers with the express permission of the user.

17. A computer program product tangible stored on a computer readable storage device comprising instructions for causing a processor to
receive provider content in various media from a plurality of provider sources to provide a private portal access to users
select providers from the plurality of providers;
store users own information as well as selected content from selected providers into a private firm library where users can add comments and tags to the content;
produce analytical data by comparing a provider's sales production data with a providers content consumption, to benchmark provider content consumption against other firms of similar nature; and
report user analytical data back to selected providers.

18. The product of claim 17 wherein user use of content is maintained private and is only shared with providers with the express permission of the user.
